(19) United States
(12) Patent Application Publication
(10) Pub. No.: US 2014/0250919 A1
(43) Pub. Date: Sep. 11, 2014

(54) PORTION COOLER

(71) Applicant: Andreas OBERMAIER, Hohenkammer (DE)

(72) Inventor: Andreas Obermaier, Hohenkammer (DE)

(21) Appl. No.: 14/349,344

(22) PCT Filed: Oct. 5, 2012
(86) PCT No.: PCT/EP2012/004187

§ 371 Date: Apr. 3, 2014

(30) Foreign Application Priority Data
Oct. 6, 2011 (DE) 10 2011 115 004.1

(51) Int. Cl. B67D 3/00; F25B 21/02

(52) U.S. Cl. CPC B67D 3/0009; F25B 21/02; F25B 2321/02
USPC 62/3.64

(57) ABSTRACT

A device for cooling beverages comprises a cooling chamber 3, a supply arrangement 31, a dispensing arrangement 4 and at least one thermoelectric converter 5. The cooling chamber encloses a hollow space 35, 36, 37, 38. The supply arrangement is configured to supply a liquid to the hollow space enclosed by the cooling chamber. The dispensing arrangement is configured to withdraw liquid from the hollow space enclosed by the cooling chamber, and the at least one thermoelectric converter has a first surface through which an amount of cooling is delivered when the thermoelectric converter is supplied with electric energy. In the device the first surface is in thermal contact with the cooling chamber, and the cooling chamber includes in its interior at least one array of spaced apart fins 34, each extending from one of the sidewalls of the cooling chamber into the interior thereof.

The invention relates to a cooling device for a proportioned cooling of beverage liquids.

In gastronomy high importance is attached to the serving of cooled beverages, and it is strived at serving the beverages promptly after an order has been placed. For this purpose, the beverages are kept at serving temperature in specifically designed refrigerating rooms or cooling containers, or the beverages are served on ice. As some spirituous beverages require particularly low serving temperatures, which are, in part, significantly below 0° C., these beverages are usually kept in specific freezer containers, such as deep freeze cabinets or deep freeze boxes at storage temperatures of down to −10° or even below. Some of such deep freeze containers are formed with a transparent front to visually display the cold spirit drinks stored therein. However, the space available for presentation at the bar counter is usually very limited so that deep freeze containers with displayable contents of only a small volume capacity are usually employed. Therefore, bottlenecks are likely to occur in case of strong demand if no additional storage capacity in deep freeze devices outside the presentation area or outside the grasp of the bar personnel is provided, such as in separate storage rooms outside the bar counter. Storage deep freeze devices required for such purpose increase the maintenance costs of a catering business because of the additional space required and the energy required for the preventive cooling of the beverages.

To solve this problem utility model G 93 00 986.0 proposes a bottle holder for a dosing device for spirituous beverages which is connected to Peltier elements to thermoelectrically cool the bottles fastened to the bottle holder. The cooling of the bottle contents is effected by thermal contact of the bottle with a cooled surface of the bottle holder. As bottles are generally poor heat conductors and, moreover, the bottle holder contacts only a fraction of the bottle surface, the cooling effect of this device is limited. Moreover, the bottle cannot be cooled down to temperatures of below the freezing point, because, due to humidity, they would undesirably be covered with an ice layer.

Utility model DE 20 2008 004 284 U1 discloses a device for continuous flow cooling of beverages which eliminates a time-consuming cooling of beverages in a bottle before being served. In order to cool the beverage liquid it is, upon demand, poured into the device which comprises a heat exchanger in which plural flow channels are provided for the beverage liquid to pass through. The cooling of the heat exchanger is effected by means of Peltier element such that the liquids, after having passed through the device, have about refrigerator temperature.

Laid-Open Print DE 40 36 210 A1 also describes a continuous flow cooling realized by means of Peltier elements, wherein, in contrast to DE 20 2008 004 284 U1, the beverage liquid does not pass through plural parallel flow channels, but through a single zigzag flow channel. In this device the serving temperature is adjusted by controlling the throughflow velocity. In order to avoid icing, cooling down to the freezing point or below is prevented by a control using a temperature sensor.

Laid-Open Print DE 10 2007 028 329 A1 also proposes a continuous flow beverage cooler, wherein the heat exchanger has only a single flow channel for the beverage liquid to pass through. In order to obtain a large heat exchange area with relative small dimensions, the flow channel is configured helically. The cooling of the heat exchanger may be effected, among others, by use of Peltier elements.

The above-described flow coolers for beverage liquids are not configured to cool spirituous beverages down to temperatures below the freezing point. When serving spirituous beverages in catering businesses a usual portion of 2 cl (1 cl is 0.01 liter) should be withdrawable within 2 seconds from the bottle. The above-described flow coolers do not allow a cooling of such an amount within such a short time and would also require a disproportionately high amount of cooling and thus disproportionately large cooling aggregates.

It would, therefore, be desirable to provide a cooling device which allows a cooling of limited quantities of beverage liquids down to temperatures below the freezing point within an appropriate period of time.

Such cooling arrangement includes a device for cooling the beverages which comprises a cooling chamber, a supply arrangement, and a dispensing arrangement and at least a thermoelectric converter. The cooling chamber encloses a hollow space configured to accommodate a liquid, the supply arrangement is configured to supply a liquid to the hollow space enclosed by the cooling chamber, the dispensing arrangement is configured to withdraw liquid from the hollow space enclosed by the cooling chamber, and the at least one thermoelectric converter has a first surface through which an amount of cooling is delivered when the thermoelectric converter is supplied with electric energy. In the device, the first surface is in thermal contact with the cooling chamber, the cooling chamber including in its interior at least one array of spaced apart fins, each extending from one of the sidewalls of the cooling chamber into the interior thereof. It is a characteristic of the device for cooling beverages that the dispensing arrangement is configured to dispense liquid in doses of predetermined single withdrawal quantities from the hollow space and the volume of the hollow space corresponds at least to the volume of a single withdrawal quantity.

In this connection, it is pointed out that the terms “comprise”, “having” “include”, “contain” and “with”, as used in the description and claims for the recital of features, as well as their grammatical modifications, are to be understood as non-limiting recitals of features, such as, for example, components, process steps, devices, portions, dimensions and the like, and exclude in no way the presence of other or additional features or arrays of other or additional features.

The described cooling device are configured to cool limited volumes of liquid, the quantity of liquid to be cooled after a withdrawal of liquid has occurred corresponding exactly to a single withdrawal quantity, or portioned dose, of liquid. The amount of cooling required by the thermoelectric converter is thus reduced to cooling this quantity of liquid to serving temperature within a predetermined period of time. As the liquid need not be cooled in a continuous flow, the cooling channel can be provided shorter and the cooling chamber can thus be designed more compact than in continuous flow coolers.

In preferred embodiments, a portion extending from the dispensing arrangement to the supply arrangement within the hollow space enclosed by the cooling chamber is not penetrated by the fins, which enables a continuous circulation of the cooled liquid in the hollow space, and it is thus ensured that it is always the coolest part of the liquid which is present at the outlet of the cooling device and warmer or warming-up liquid quantities are returned into the cooling circuit.

In order to ensure that at the outlet of the cooling device warming-up liquid does not inhibit an inflow of cooler liquid from the fins, it is, according to embodiments, preferred for the portion of the hollow space which is not penetrated by a fin to have a first partial portion which is disposed in the lower part of the hollow space contiguous to the dispensing arrangement. In order to effectively supply a liquid warmed in the hollow space of the cooling chamber to the cooling fins, the portion of the hollow space which is not penetrated by a fin comprises, according to advantageous embodiments, a second partial portion which is disposed in the upper portion of the hollow space contiguous to the supply arrangement. In particularly preferred embodiments, the portion of the hollow space through which no fin extends comprises, in addition, a third partial portion which is provided to allow a liquid to flow from a hollow space section near the dispensing arrangement to a hollow space section near the supply arrangement, thus allowing a backflow of warmed liquid undisturbed by the fins. In this connection, it is pointed out that the terms “up” and “down” as used herein relate to the flow direction of the liquid in the cooling chamber from the supply arrangement to the dispensing arrangement, “up”, in respect of the cooling chamber, meaning the direction towards the supply arrangement and “down” meaning the direction towards the discharge direction. If the liquid flow is caused by gravity, the term “up” and “down” have the generally common meaning.

In preferred embodiments of the cooling device, the volume of the hollow space is at least twice and maximally ten times the volume of a single withdrawal quantity, i.e., of a portioned dose, so that the amount of cooling provided by the cooling device and thus its dimensions can be adapted to the expected tapping frequency. By tapping frequency it is understood here the frequency at which the liquid portions cooled to serving temperature are withdrawn from the cooling device. To provide a cooling volume of at least two portioned doses ensures that directly after a first portioned dose has been withdrawn a second portioned dose can also be withdrawn at serving temperature. In order to ensure that the temperature of further single withdrawal quantities withdrawn shortly after does not exceed a specific serving temperature, it is preferable for the cooling volume of the hollow space to correspond to more than two portioned doses, in preferred embodiments, however, no more than about ten portioned doses, because then the period of time available for cooling down newly introduced liquid quantities usually suffices to provide the liquid at the outlet always at serving temperature. It has been found that already a cooling volume which is six times the volume of a single withdrawal quantity suffices to meet the usual demands in catering businesses to be able to tap at serving temperature at all times. According to specific embodiments, it is of course also possible to have a cooling volume which accounts for more than ten portioned doses, in particular in cases which require a good cooling also at high tapping frequencies over longer periods of time, for example, for servings at festivals.

In order to prevent the cooled liquid from being warmed up by ambient air or to prevent the surfaces of the cooling device from icing, according to embodiments, at least the exposed outer surfaces of the cooling chamber are surrounded by a thermally insulating material. By exposed surfaces it is meant in this document the outer surfaces, which are not covered by any further components of the cooling device.

It is appropriate for further embodiments of the cooling device to comprise a control unit for detecting a liquid temperature in at least one portion of the hollow space and for controlling the supply of electric energy to thermoelectric converter dependent on a detected liquid temperature. Such a control unit enables to control the amount of cooling dependent on the amount of withdrawal, for example, in such a way that the liquid which is present in the cooling chamber, after liquid has been withdrawn, is cooled down with a maximum amount of cooling and after a predetermined threshold temperature, which is allocated to the serving temperature, has been reached or it has been fallen below such a threshold temperature is held at this temperature with only a little amount of cooling.

Furthermore, embodiments may advantageously comprise a display controllable by the control unit, said display having at least two display states, and said controller being configured to change the state of the display means dependent on the detected liquid temperature and to activate at least one of the display states when the detected liquid temperature is less or equal to a predetermine threshold temperature. A display controlled in such a manner enables the operator to recognize whether the temperature in the cooling chamber or at the outlet of the cooling chamber has already cooled down to the predetermined serving temperature. In simple embodiments, the display means comprises a light-emitting element which can be switched on and off by the control unit.

In order to release heat energy withdrawn from the liquid in the cooling chamber and power dissipation produced by the thermoelectric effectively to the environment with high efficiency, the thermoelectric converter comprises, according to further advantageous embodiments, a second surface which, when the thermoelectric converter is supplied with electrical energy, heats up dependent on the amount of cooling provided via the first surface, and is thermally connected with a cooling device adapted to transfer heat energy to the environment.

According to embodiments, the thermoelectric converter advantageously comprises one or more Peltier elements to achieve a compact design.

Further features of the invention are evident from the following description of embodiments in combination with the claims and the Figures. It is pointed out that the invention is not limited to the described embodiments, but is defined by the scope of the claims annexed hereto. In particular, the individual features of the described embodiments may be realized in the embodiments of the invention in different number and combination. Further, the number and combination of features of embodiments of the invention can also deviate from the embodiments as described herein below.

In the following description of individual embodiments, reference is taken to the attached Figures, wherein

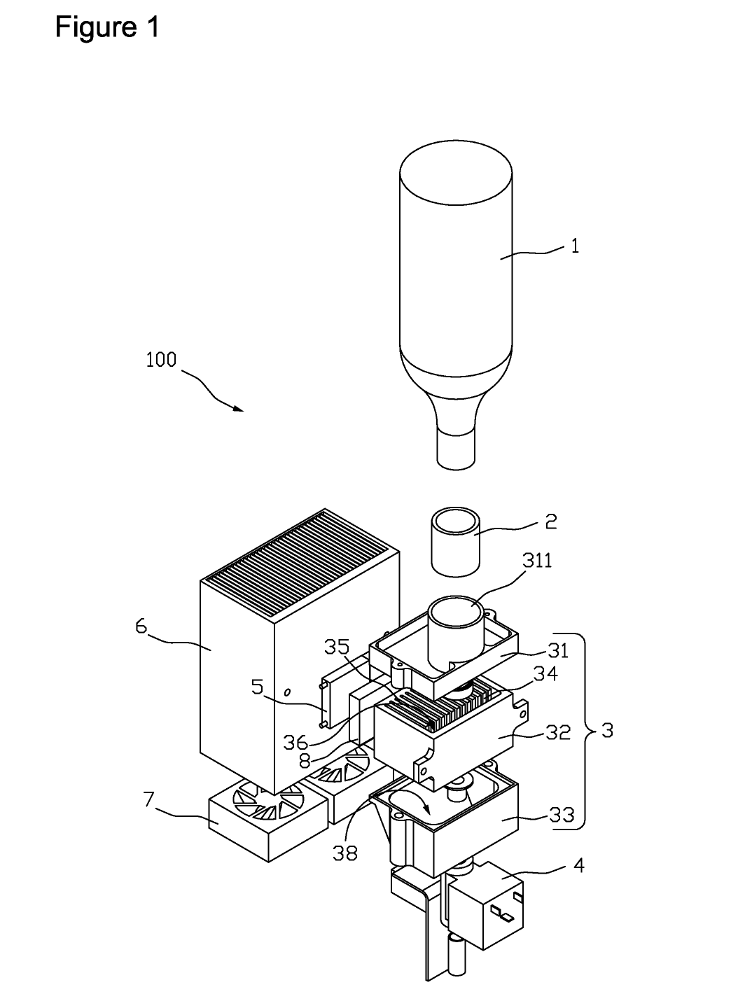

FIG. 1 shows a first embodiment of a portion cooler in a schematic explosive view,

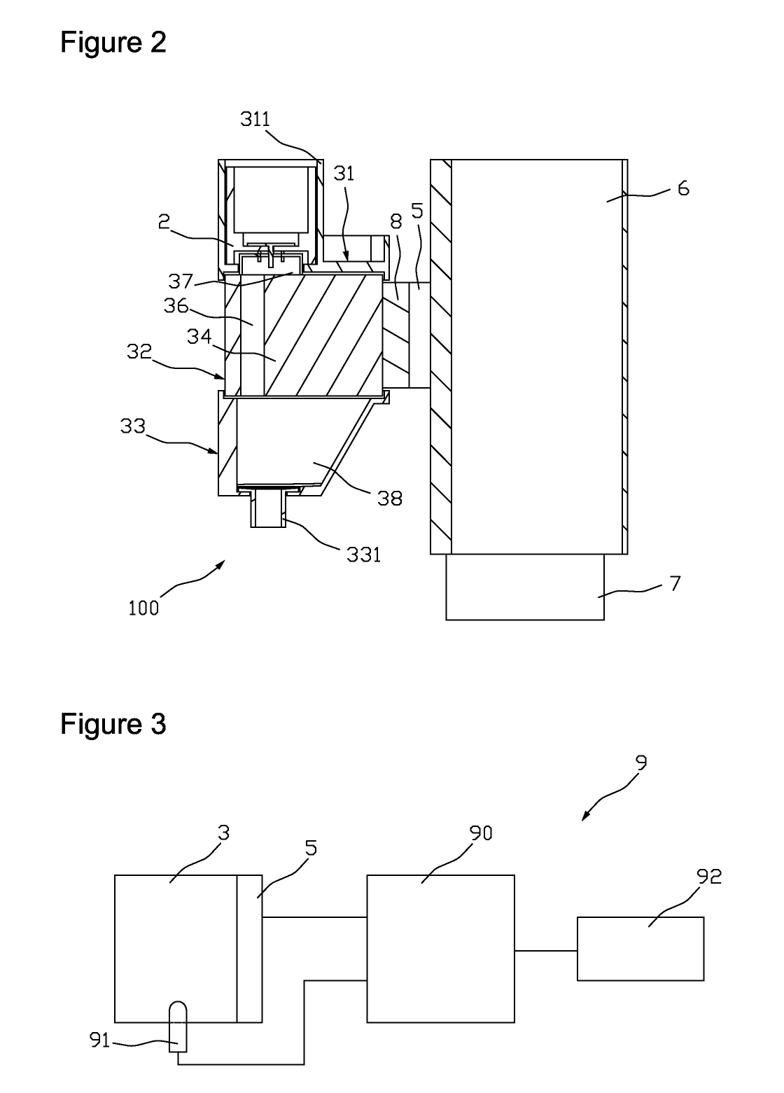

FIG. 2 shows a second embodiment of a portion cooler in a schematic longitudinal section, and

FIG. 3 is a block diagram for illustrating a temperature-controlled cooling control and temperature display.

In the drawings elements which fulfil substantially the same technical functions are designated by the same reference numbers. Different embodiments of these elements are designated by similar reference numbers. Moreover, only those components of the respective illustrated subject matter are shown which are necessary for the understanding of the present invention. For the sake of a clear presentation, further components of the respective illustrated embodiments are not shown.

The strongly schematic perspective explosive view of FIG. 1 shows the main components of a portion cooler 100 for use with spirituous beverages or other beverage liquids available from bottles 1. The liquid container 1 shown in the Figure does not form part of the portion cooler 100. The liquid container 1 is shown merely to illustrate the function of the portion cooler 100.

The portion cooler 100 comprises a bottle valve 2, a liquid cooler 3, an outlet or tap valve 4, a thermoelectric converter 5, a cooling device 6, a fan 7, if appropriate, for increasing the air circulation at the cooler device and, optionally, a heat conducting element 8 configured to transfer heat energy from the liquid cooler 3 to the thermoelectric converter 5. The bottle valve 2 is configured to receive the outlet of a bottle 1 standing upside down. The outlet or tap valve 4 is configured to withdraw a liquid from the liquid cooler 3, and the cooling device 6 is configured to transfer thermal energy to ambient air.

Preferably, arrays of Peltier elements are used for the thermoelectric converter 5, because they enable a particularly compact design and require no further operating resources, such as, cooling agents. The cooling side of the Peltier elements is thermally connected with the liquid cooler 3, while the warming side of the Peltier element is in thermal contact with the cooling device 6 to thus transfer heat energy withdrawn from a liquid present in the liquid cooler 3 together with the heat energy produced by the Peltier elements via the cooling device 6 to ambient air. In preferred embodiments, the cooling device 6 is provided as metal cooling body which, in order to provide a maximum heat transferring area, is provided with plural cooling ribs. In the embodiment shown in FIG. 1, the cooling ribs are disposed within a lateral enclosing so that the cooling body provides plural parallel cooling air channels disposed adjacent each other. As a result, the cooling air stream is guided in defined manner over the heat-discharging surfaces of the cooling body 6. This reduces the possibility of an undesired warming-up of adjacent objects in the bar or counter area. The outlet of the cooling body can be connected via a channel (not shown in the figure) with an exhaust air system. In order to improve the heat discharge, a ventilation means 7 may be provided at the bottom of the cooling body which increases the flow velocity of the cooling air. The ventilation means 7 may of course be also mounted above the cooling body. In some embodiments, the cooling air may also be supplied up-down, instead as supposed above down-up.

The core of the portion cooler 100 is the liquid cooler 3 which comprises, in the embodiment shown, three structural components: a liquid supply arrangement 31, a finned cooler 32 and an outlet basin 33 which merges into the dispensing arrangement 4. The outer walls or sidewalls of the finned cooler 32 laterally enclose the cooling volume. The finned cooler 32 is configured open in the direction of the liquid supply arrangement 31 and the outlet basin 33 so that liquid can flow into the finned cooler 32 through the liquid supply arrangement and fill the outlet basin 33. The liquid transport through the finned cooler 32 is preferably effected based on gravity. Therefore, the side of the finned cooler 32 directed towards the liquid supply arrangement 31 is referred to hereunder as the “top” thereof and the side of the finned cooler directed towards the outlet basin 33 is referred to as the “bottom” thereof. This designation is used in the following independent of the actual orientation of the finned cooler 32, i.e., also for applications wherein the liquid is transported obliquely, horizontally or against gravity, e.g., by pumps.

The outer side of at least one of the sidewalls of the finned cooler 32 is configured such that it can be brought into thermal contact with the thermoelectric converter 5. Plural fins 34 extend into the cooling volume of the finned cooler enclosed by the sidewalls, the feet areas of said fins being in direct thermal contact with one of the sidewalls. Each of the fins has the shape of a cooling rib, the cooling surfaces of which extend in the direction from the top of the finned cooling system to the bottom thereof. The spaced apart fins 34 may extend through the entire cooling volume, thus providing plural adjacently extending cooling channels which are separated from each other by the fins.

According to preferred embodiments, the fins extend, however, only through a part of the cooling volume. The backflow portion 36 through which no fins extend defines a passage from the outlet basin past the cooling fins 34 towards the top of the finned cooler 32 and serves to maintain a continuous circulation through which the liquid passes from the outlet basin 33 past the fins 34 to the top of the fins 34. The continuous flow may be accomplished by means of pumps. In preferred embodiments, wherein the liquid is transported between the fins under the influence of gravity, the continuous circulation is, however, provided by a convection flow, wherein liquid warming up in the outlet basin 33 below the fins 34, due to its relative lower specific weight, rises via the backflow portion 36 to the top of the finned cooler 32, reaches the fins 34, is cooled down by the fins and, due to the now relatively higher specific weight, eventually, owing to gravity, sinks down again to the outlet basin.

In the embodiment illustrated in FIG. 1, the finned cooler 32 is of rectangular shape. The fins 34 merge with the inner side of the sidewall provided for connection with the thermoelectric converter 5 and are disposed in parallel to one another. The spaces 35 formed between the fins 34 define cooling channels for a liquid to be passed along the cooling fins. The fins extend in the direction towards the opposed sidewall of the finned cooler 32, the length of the fins being shorter in this direction than the distance between the sidewalls. The height of the fins corresponds in the depicted embodiment substantially to the height of the finned cooler 32, i.e., to the space between the top and bottom thereof. The width of the fins 34 and the distance between the fins are optimised for a maximum removal of heat from a liquid flowing around the fins. The optimisation can be effected by way of experiment as well as by way of calculation according to a mathematical model or by way of simulation. The embodiment shown in FIG. 1 is, however, not mandatory. For example, it is also possible that fins are provided at three of the sidewalls, the central one of the three sidewalls being preferably cooled via the thermoelectric converter. This enables, with a sufficient wall thickness of the sidewalls contiguous to the fins, a stronger cooling of the portion further remote from the sidewall connected with the thermoelectric converter 5. In other embodiments, the finned cooling device 32 comprises, instead of plural sidewalls, one continuous enclosing wall which is configured over a partial area for connection with the thermoelectric converter 5. Other than in the illustration of FIG. 1, the enclosing wall or the sidewalls between the top and bottom of the finned cooler 32 may also be curved or may have one or more bendings. In order to increase the cooling area, the fins may have, instead of a plane surface, also structured, e.g., corrugated surfaces.

As is evident from the longitudinal section of FIG. 2, the top of the finned cooler 32 is covered by the liquid supply arrangement 31. The liquid supply arrangement 31 comprises an accommodation 311 for a bottle valve 2 which is preferably configured for connection to a liquid container, e.g., a bottle or liquid feeder. By liquid feeder it is meant here adapters for connection with different containers as well as also longer channels suitable for guiding liquids, for example, pipes. The bottle valve forms part of the liquid supply arrangement 31. In order to allow liquid to be withdrawn, the bottle valve 2 comprises in preferred embodiments a ventilation system through which air may be introduced into the container 1. Further, it is thus prevented that a negative pressure is produced in the container. The liquid supply arrangement 31 comprises in preferred embodiments furthermore a hollow space 37 which is disposed above the cooling volume enclosed by the finned cooler and is contiguous to the same and appropriately extends at least over the spaces 35 formed between the fins.

The bottom of the finned cooler 32 is contiguous to the outlet basin 33 which encloses a liquid reservoir 38 which is contiguous to the cooling volume of the finned cooler 32. The outlet basin 33 is furthermore configured, e.g., by means of a connecting piece 331, for connection with an outlet or tap valve 4, which allows a portioned withdrawal of liquids from the liquid reservoir 38. The tap valve may be in the form of a mechanic dosing valve. In preferred embodiments, the tap valve comprises a solenoid valve. The tap valve 4 is mounted on the outlet basin such that a liquid upstream of the valve is constantly in thermal contact with the other liquid in the liquid reservoir 38.

The cooling volume enclosed by the finned cooler 32, the volume of the hollow space 37 and the volume of the liquid reservoir 38 define a coherent total volume, the dimension of which corresponds at least to the volume of one portioned dose which can be withdrawn from the portion cooler 100 via the tap valve at a single use. In order to ensure that the liquid can always be withdrawn at the desired serving temperature also in the event of plural tappings over short periods of time, the total volume is in preferred embodiments plural times that of one portion volume. Total volumes which are two times to ten times one portion volume are particularly preferred. Smaller total volumes which are provided for a lower tapping frequency can be provided with smaller and thus less expensive thermoelectric converters 5 and, as they require smaller cooling device 6, can be manufactured with smaller dimensions and thus more compact. As against that, larger total volumes ensure also at a high tapping frequency a sufficient low serving temperature. The total volume in embodiments which are configured for high tapping frequencies over longer periods of time may also be more or considerably much more than ten times the volume of one portioned dose.

The shape and size of the hollow space 37 are governed by the structural conditions of the supply valve 2 and the requirement that, on the one hand, a liquid supplied via the bottle valve 2 must be transferred into the cooling volume of the finned cooler 32 without any greater flow resistance, and, on the other hand, liquid rising via the backflow portion 36 must be guided through the spaces 35 to the fins 34. Since the cooling surface surrounding the hollow space 37 of the liquid supply arrangement 31 is relatively small, the proportion of the hollow space 37 of the total cooling volume of the liquid cooler must be kept very small as well and it is preferably less than half a portioned dose.

The ratio of the cooling volume enclosed by the finned cooler 32 to the volume of the liquid reservoir 38 is dependent on the size of the total volume of the liquid cooler 3. If the total volume corresponds to only one portioned dose, the cooling volume of the finned cooler preferably accounts for at least 80%, further preferred up to 95% of the total volume of the liquid cooler 3. In order to achieve this, the fins 34 of specific embodiments may extend beyond the bottom of the finned cooler 32 into the liquid reservoir 38 of the outlet basin 33. In further embodiments, the cooling fins 34 may also extend into the hollow space 37 of the liquid supply arrangement 31. If the total volume is higher, the ratio may be varied in favour of the size of the liquid reservoir 38 so that, in the case of a particularly preferred total volume of about six portioned doses, the volume of the liquid reservoir 38 accounts for about 75% and the cooling volume of the finned cooler 32 accounts for slightly less than 25% of the total volume. For smaller total volumes both volumes may be about the same. In other embodiments, the cooling volume of the liquid reservoir may also be significantly below 75% up to only a few percentages.

In particularly preferred embodiments, a part of the cooling volume enclosed by the finned cooler is not penetrated by cooling fins in order to provide a backflow portion 36. This allows the above-described circulation of a liquid present in the total cooling volume of the liquid cooler 3 which is caused passively by thermal convection in the embodiments illustrated in FIGS. 1 and 2. In other embodiments the liquid circulation is actively maintained by a pumping means disposed at an appropriate location in the total cooling volume, for example, at the inlet to the backflow portion 36. In alternative embodiments to the ones shown in FIGS. 1 and 2, the backflow portion 36 may also be provided as closed fluid circuit surrounding the cooling fins 34 and the spaces 35 therebetween. By circulating the liquid in the liquid cooler 3 it is ensured that the coolest liquid is always in the liquid reservoir even after longer times of non-use and tapped via the outlet valve 4.

According to preferred embodiments, the liquid cooler comprises no pumping means for maintaining a circulation of the cooling or cooled liquid, so that the circulation is solely effected by internal natural convection supported through the backflow portion 36. In order to further support such a convection, the outlet basin 33 of embodiments is streamlined in terms of convection. To this end, the embodiment shown in FIGS. 1 and 2 has a sloped backside over which the liquid flowing in from the cooling ribs is directed towards the backflow portion 36 and thus warmed liquid is prevented from rising against the down falling flow of liquid cooled by the cooling fins.

The present invention utilizes the fact that in catering business spirituous beverages are usually withdrawn from liquid containers in portioned doses, one portioned dose being usually, depending on the purpose of the spirituous beverage, between 2 and 4 cl. When a portioned dose is withdrawn from the liquid cooler 3, the liquid flows out of the outlet basin 33 through the outlet valve 4. The resulting decreasing fill level in the total cooling volume of the liquid cooler 3 causes an air stream to flow via the bottle valve 2 into the liquid container 1 to compensate for a negative pressure in the liquid container 1, so that a liquid quantity, which corresponds to the liquid quantity previously withdrawn through the outlet valve 4, may flow into the liquid cooler. In order to avoid a negative pressure in the liquid container, it is ventilated as describe above via the supply valve during a liquid withdrawal. The liquid supply may be effected directly into the spaces 35 between the cooling fins or, as in the case of the depicted embodiment, at least partially into the backflow portion 36, which results into a lower flow resistance and thus allows quicker tapping. After a tapping process has been completed, liquid freshly supplied to the backflow portion 36 rises quickly and passes via the hollow space 37 into the cooling channels formed by the spaces 35, which causes a quick cooling of the freshly supplied liquid.

A portion cooler as described above cools between two tapping processes always only a liquid quantity which corresponds to one portioned dose. A mixing of cooled and uncooled liquid during a tapping process is negligible due to the different specific weights. Accordingly, the amount of cooling can be adapted to the portioned dose, which enables a compact design of the portion cooler. In order to optimally utilize the amount of cooling introduced into the liquid cooler, the portion cooler comprises in some embodiments (not shown in the Figures) an outer insulation which also prevents an icing of the cooler surface. When use is made of thermoelectric converters 5 which are thinner in relation to the insulating layer, the thermal contact between converter 5 and finned cooler or between converter 5 and cooling device 6 can be made by use of a suitable heat-conducting element 8. All materials involved in withdrawing thermal energy from a liquid contained in the liquid cooler 3 and in transferring thermal energy to ambient air exhibit a good thermal conductivity of preferably more than 150 W/(m·K) and in particular more than 200 W/(m·K). If use is made of aluminium for manufacturing the liquid cooler, the natural surface oxide is usually sufficient for providing food-safe surfaces. Instead of the natural oxide layer, the surface of the aluminium body or bodies may also be provided with a food-safe anodized layer. Moreover, the surface of the liquid cooler 3 in contact with the liquid can also be coated with a thin food-safe plastic layer, especially if metals or metal alloys are used which might react with the liquid to be cooled.

FIG. 3 shows a block diagram from which the essential components of a cooling performance control 9 for a cooling device in the form of a portion cooler 100 as described above and a temperature display linked to a liquid temperature in the portion cooler are evident.

The cooling performance control 9 comprises a controller 90, a temperature sensor 91 and a display means 92. Depending on its design, the temperature sensor 91 is configured to change one of its characteristics or to deliver an electric signal dependent on the temperature in its sensing area. For example, the temperature sensor may be formed by a thermistor, a thermocouple or a semiconductor circuit. The temperature sensor 91 is preferably provided at the liquid cooler 3 such that its sensing area contacts a liquid contained in the liquid cooler 3. It is appropriate for the sensing area of the temperature sensor 91 to be in the vicinity of the tap valve 4. The controller 90 is connected both to the temperature sensor 91 and to the thermoelectric converter 5 and configured to control the current flow through the thermoelectric converter dependent on the state of the temperature sensor 91. The control can be effected either directly in that the controller 90 itself produces the supply current for operating the thermoelectric converter 5 or indirectly in that the control produces a current control signal which is delivered to a controllable current source (not shown in the Figure) for the thermoelectric converter 5.

In order to display information of a cooling status of a liquid contained in the liquid cooler 3 or the ready status of the portion cooler 100, embodiments of the cooling performance control 9 further comprise a display means 92, the states of which can be controlled by the controller 90. In particular, the controller 90 is configured to control the state of the display means 92 dependent on specific states of the thermoelectric converter 91. In embodiments the display means 92 comprises at least one light-emitting element, for example a light diode, which is controlled by the controller to emit light as soon as the liquid temperature detected by the temperature sensor 91 has been reached or is less than a predetermined value. In other embodiments the display may comprise at least two light-emitting elements, one of which only lights when the predetermined liquid temperature has neither been reached nor fallen below, while the other one only lights when the predetermined temperature has been reached or is less. In other embodiments the display means may additionally or alternative comprise a graphic display unit such as, e.g., a numerical or alphanumerical digital display, which allows to display a temperature detected via the temperature sensor 91 or also status messages such as “ready to tap” or the like.

The above-described portion cooler allows a quick cooling of beverages to very low temperatures after a tapping process has been completed in that it is always a beverage volume of only one or a few tapping portions which is/are cooled. In order to accelerate the cooling, the portion cooler not only comprises a large cooling surface contacting the liquid to be cooled, but also causes a liquid circulation which ensures that it is always an optimally cooled liquid which is available at the tap valve. If cooling volumes are used which are plural times the tap portion, the tapping frequency can be significantly increased, because after a tapping process has been completed there is, on the one hand, further optimally cooled liquid available and, on the other hand, the liquid which has not been cooled is, due to the tapping process, immediately passed over the cooling surfaces and thus optimally cooled until it reaches the tap valve.

In order to cool a beverage liquid contained in a liquid container 1, for example a bottle, in a portion cooler as described above, the container is mounted on the supply arrangement 31 such that liquid contained in the liquid container 1 may enter the cooling chamber 3 via the supply arrangement 31. After the liquid contained in the cooling chamber 3 has been cooled, a specific quantity of the cooled liquid corresponding to one portion is, upon demand, withdrawn from the cooling chamber by use of the dispensing arrangement 4. The volume of the liquid quantity withdrawn in this process does not exceed the volume of the liquid contained in the cooling chamber 3. The withdrawal process may be effected repeatedly.

1. A device for cooling spirituous beverages available from bottles, the device comprising
a cooling chamber enclosing a hollow space configured to accommodate a liquid,
a supply arrangement which is configured to supply a liquid to the hollow space enclosed by the cooling chamber,
a dispensing arrangement which is configured to withdraw liquid from the hollow space enclosed by the cooling chamber, and
at least one thermoelectric converter having a first surface through which an amount of cooling is delivered when the thermoelectric converter is supplied with electric energy,
wherein the first surface is in thermal contact with the cooling chamber, and the cooling chamber includes in its interior at least one array of spaced apart fins, each extending from one of the sidewalls of the cooling chamber into the interior thereof,
characterized in that
the dispensing arrangement is configured to withdraw liquid in portioned doses of predetermined single withdrawal quantities from the hollow space,
the volume of the hollow space corresponds to at least the volume of one single withdrawal quantity,
each one of the spaces formed between the fins extends from the hollow space of the cooling chamber contiguous to the supply arrangement to the hollow space of the cooling chamber contiguous to the dispensing arrangement, and
the device comprises a backflow portion connecting a hollow space contiguous to the dispensing arrangement with a hollow space contiguous to the supply arrangement.

2. The device according to claim 1, wherein the backflow portion is configured as an area of the hollow space which is contiguous to the fins, but is not penetrated by the fins.

3. The device according to claim 2, wherein the hollow space has a first partial portion which is disposed in the lower part of the hollow space contiguous to the dispensing arrangement and is not penetrated by a fin.

4. The device according to claim 2, wherein the hollow space has a second partial portion which is disposed in the upper part of the hollow space contiguous to the supply arrangement and is not penetrated by a fin.

5. The device according to claim 3, wherein the portion of the hollow space which is contiguous to the dispensing arrangement and is not penetrated by a fin has a shape which allows a gravity-based supply of a liquid present in this portionto the backflow portion.

6. The device according to claim 1, wherein the volume of the hollow space is at least two times and maximally ten times the volume of one single withdrawal quantity.

7. The device according to claim 1, wherein the volume of the hollow space is about six times the volume of a single withdrawal quantity.

8. The device according to claim 1, wherein at least the free outer surfaces of the cooling chamber are surrounded by a thermally insulating material.

9. The device according to claim 1, comprising a controller for detecting a liquid temperature in at least one area of the hollow space and for controlling the supply of electrical energy to the thermoelectric converter dependent on a detected liquid temperature.

10. The device according to claim 9, further comprising a display means controlled by the controller, said display means having at least two display states, and said controller being adapted to change the state of the display means dependent on the detected liquid temperature and to activate at least one of the display states when the detected liquid temperature is less or equal to a predetermined threshold temperature.

11. The device according to claim 1, wherein the thermoelectric converter has a second surface which, when the thermoelectric converter is supplied with electrical energy, heats up dependent on the amount of cooling emitted over the first surface, and is thermally connected with a cooling device adapted to transfer heat energy into the environment.

12. The device according to claim 1, wherein the thermoelectric converter comprises one or more Peltier element(s).

13. A method for cooling a beverage liquid by use of a device according to claim 1, wherein the method comprises the steps of
mounting a liquid container on the supply arrangement such that a liquid contained in the liquid container may enter through the supply arrangement into the cooling chamber,
cooling the liquid contained in the cooling chamber, and
withdrawing a specific amount of cooled liquid by use of the dispensing arrangement, wherein the volume of the withdrawn liquid quantity does not exceed the volume of the liquid contained in the cooling chamber.

14. The device according to claim 3, wherein the hollow space has a second partial portion which is disposed in the upper part of the hollow space contiguous to the supply arrangement and is not penetrated by a fin.

15. The device according to claim 4, wherein the portion of the hollow space which is contiguous to the dispensing arrangement and is not penetrated by a fin has a shape which allows a gravity-based supply of a liquid present in this portion to the backflow portion.

16. The device according to claim 2, comprising a controller for detecting a liquid temperature in at least one area of the hollow space and for controlling the supply of electrical energy to the thermoelectric converter dependent on a detected liquid temperature.

17. The device according to claim 3, comprising a controller for detecting a liquid temperature in at least one area of the hollow space and for controlling the supply of electrical energy to the thermoelectric converter dependent on a detected liquid temperature.

18. The device according to claim 2,
wherein the thermoelectric converter has a second surface which, when the thermoelectric converter is supplied with electrical energy, heats up dependent on the amount of cooling emitted over the first surface, and is thermally connected with a cooling device adapted to transfer heat energy into the environment.

19. The device according to claim 3,
wherein the thermoelectric converter has a second surface which, when the thermoelectric converter is supplied with electrical energy, heats up dependent on the amount of cooling emitted over the first surface, and is thermally connected with a cooling device adapted to transfer heat energy into the environment.

20. A device for cooling spirituous beverages available from bottles, the device comprising
a cooling chamber enclosing a hollow space configured to accommodate a liquid,
a supply arrangement which is configured to supply a liquid to the hollow space enclosed by the cooling chamber,
a dispensing arrangement which is configured to withdraw liquid from the hollow space enclosed by the cooling chamber, and
at least one thermoelectric converter having a first surface through which an amount of cooling is delivered when the thermoelectric converter is supplied with electric energy,
wherein the first surface is in thermal contact with the cooling chamber, and the cooling chamber includes in its interior at least one array of spaced apart fins, each extending from one of the sidewalls of the cooling chamber into the interior thereof,
characterized in that
the dispensing arrangement is configured to withdraw liquid in portioned doses of predetermined single withdrawal quantities from the hollow space,
the volume of the hollow space corresponds to at least the volume of one single withdrawal quantity,
each one of the spaces formed between the fins extends from the hollow space of the cooling chamber contiguous to the supply arrangement to the hollow space of the cooling chamber contiguous to the dispensing arrangement, and the device comprises a backflow portion connecting a hollow space contiguous to the dispensing arrangement with a hollow space contiguous to the supply arrangement,
wherein the backflow portion is configured as an area of the hollow space which is contiguous to the fins, but is not penetrated by the fins;
wherein the hollow space has a first partial portion which is disposed in the lower part of the hollow space contiguous to the dispensing arrangement and is not penetrated by a fin;
wherein the hollow space has a second partial portion which is disposed in the upper part of the hollow space contiguous to the supply arrangement and is not penetrated by a fin;
wherein the portion of the hollow space which is contiguous to the dispensing arrangement and is not penetrated by a fin has a shape which allows a gravity-based supply of a liquid present in this portion to the backflow portion; and
wherein the volume of the hollow space is at least two times and maximally ten times the volume of one single withdrawal quantity.
